(19) United States
(12) Patent Application Publication
(10) Pub. No.: US 2017/0115798 A1
(43) Pub. Date: Apr. 27, 2017

(54) TOUCH DISPLAY PANEL AND ASSOCIATED DRIVING CIRCUIT AND DRIVING METHOD

(71) Applicant: MStar Semiconductor, Inc., Hsinchu Hsien (TW)

(72) Inventors: Kai-Ting HO, Hsinchu Hsien (TW); Chi-Kang LIU, Hsinchu Hsien (TW)

(21) Appl. No.: 15/060,769

(22) Filed: Mar. 4, 2016

(30) Foreign Application Priority Data
Oct. 26, 2015 (TW) 104135010

(51) Int. Cl. G06F 3/041; G09G 3/36; G06F 3/044

(52) U.S. Cl. CPC G06F 3/0416; G06F 3/044; G06F 3/0412; G09G 3/3607; G09G 3/3648; G09G 2320/0666

(57) ABSTRACT

A driving circuit for a touch display panel is selectively operable in a display mode or a touch mode. The driving circuit includes a touch driving circuit and a display driving circuit. When the driving circuit operates in the display mode, the display driving circuit transmits corresponding data to multiple data lines of a pixel array of the touch display panel. When the driving circuit operates in the touch mode, the touch driving circuit transmits a driving signal to a common electrode of the touch display panel, and the display driving circuit controls at least a part of multiple gate lines and multiple data lines of the pixel array to cause that part to have a signal waveform at least partially same as that of the driving signal. A voltage of the common electrode reflects a touch action.

This application claims the benefit of Taiwan application Serial No. 104135010, filed Oct. 26, 2015, the subject matter of which is incorporated herein by reference.

### BACKGROUND OF THE INVENTION

Field of the Invention

The invention relates in general to a touch display panel, and more particularly to an in-cell touch display panel and an associated driving circuit and driving method.

Description of the Related Art

In a conventional in-cell touch display panel, the display mode and the touch mode alternate constantly. Due to different rotation angles of liquid crystal molecules when the panel displays different colors/luminosities, as well as the incapability of immediate responses in the rotation angles of liquid crystal molecules when the touch display panel switches from the display mode to the touch mode, regions originally displaying different colors have different dielectric constants. Thus, the capacitance between common electrodes and gate/data lines is changed along with the different colors/illuminance of image frames, hence resulting in noise interference and affected accuracy of subsequent touch detection.

### SUMMARY OF THE INVENTION

An object of the present invention is to provide a touch display panel and an associated driving circuit and driving method capable of preventing noise interference caused by different rotation angles of liquid crystal particles to solve issues of the prior art.

A driving circuit of a touch display panel, selectively operable in a display mode or a touch mode, is disclosed according to an embodiment of the present invention. The driving circuit includes a touch driving circuit and a display driving circuit. When the driving circuit operates in the display mode, the display driving circuit transmits corresponding display data to multiple data lines of a pixel array of the touch display panel. When the driving circuit operates in the touch mode, the touch driving circuit transmits a driving signal to a common electrode of the touch display panel, and the display driving circuit controls at least a part of multiple gate lines and the multiple data lines of the pixel array to cause that part to have a signal waveform at least partially same as that of the driving signal. A voltage of the common electrode reflects a touch action.

According to another embodiment of the present invention, a driving method of a touch display panel includes: selectively operating in a display mode or a touch mode; when operating in the display mode, transmitting corresponding display data to multiple data lines of a pixel array of the touch display panel; when operating in the touch mode, transmitting a driving signal to a common electrode of the touch display panel, and controlling at least a part of multiple gate lines and the multiple data lines of the pixel array to cause that part to have a signal waveform at least partially same as that of the driving signal. A voltage of the common electrode reflects a touch action.

A touch display panel is disclosed according to another embodiment of the present invention. The touch display panel includes a pixel array, a common electrode and a driving circuit. The pixel array includes multiple intersecting gate lines and data lines, the common electrode is disposed on the pixel array, and the driving circuit selectively operates in a display mode or a touch mode. When the driving circuit operates in the display mode, the driving circuit transmits corresponding display data to multiple data lines of a pixel array of the touch display panel. When the driving circuit operates in the touch mode, the driving circuit transmits a driving signal to a common electrode of the touch display panel, and controls at least a part of multiple gate lines and the multiple data lines of the pixel array to cause that part to have a signal waveform at least partially same as that of the driving signal. A voltage of the common electrode reflects a touch action.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a touch display panel according to an embodiment of the present invention;

FIG. 2 is a schematic diagram of a control system of a common electrode according to an embodiment of the present invention;

FIG. 3 is a schematic diagram of signals applied on a common electrode, gate lines and data lines in a display mode and in a touch mode according to an embodiment of the present invention;

FIG. 4 is a schematic diagram of an example of a touch driving circuit in a control and detection circuit shown in FIG. 2;

FIG. 5 is a schematic diagram of an example of a source driver; and

FIG. 6 is a flowchart of a driving method of a touch display panel according to an embodiment of the present invention.

### DETAILED DESCRIPTION OF THE INVENTION

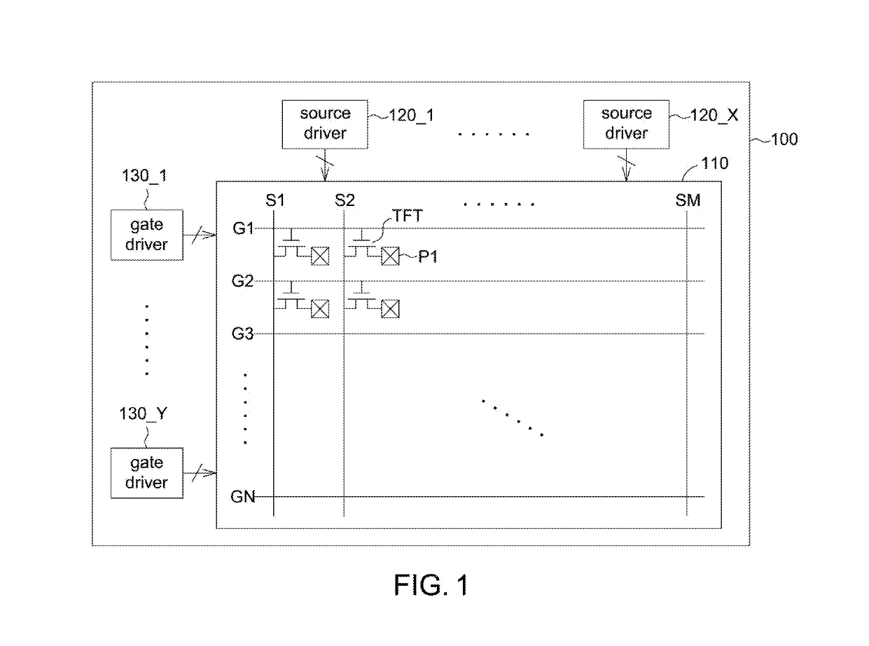

FIG. 1 shows a schematic diagram of a touch display panel 100 according to an embodiment of the present invention. As shown in FIG. 1, the touch display panel 100 includes a pixel array 110 and a driving circuit. In the embodiment, the pixel array 110 includes multiple gate lines G1 to GN and data lines S1 to SM that intersect one another, and multiple thin-film transistors TFT and their pixel electrodes P1. The driving circuit includes at least one display driving circuit. For example but not limited to, the display driving circuit includes source drivers 120_1 to 120_X and gate drivers 130_1 to 130_Y. In other embodiments, the display driving circuit may include only one single source driver or one single gate driver, or may be integrated into one single chip. Further, the gate driver may be directly fabricated on a glass substrate by gate-on-array (GOA) technologies.

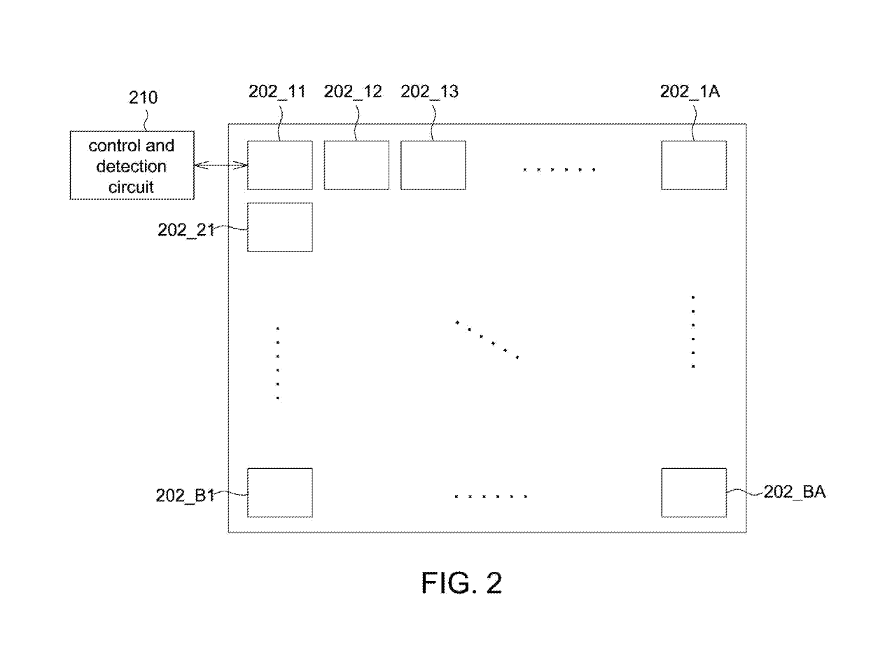

FIG. 2 shows a schematic diagram of a control system of a common electrode according to an embodiment of the present invention. As shown in FIG. 2, the common electrode is formed by multiple blocks 202_11 to 202_BA, and is disposed on the pixel array 110. In the embodiment, the touch display panel 100 is an in-cell in-plane switching (IPS) touch display panel. Thus, each of the blocks 202_11 to 202_BA can substantially be formed strip-like electrodes consisting of multiple connected blocks. Further, each of the blocks 202_11 to 202_BA is connected to a control and detection circuit 210 (i.e., this embodiment includes B*A control and detection circuits 210). The control and detection circuit 210 may be an independent circuit or integrated in the driving circuit. It should be noted that, as the architecture of the IPS touch display panel and the function elements in FIG. 1 and FIG. 2 are generally known to one person skilled in the art, and the main features of the present invention are driving signals for touch detection, the details and operations of the elements in FIG. 1 and FIG. 2 are omitted herein.

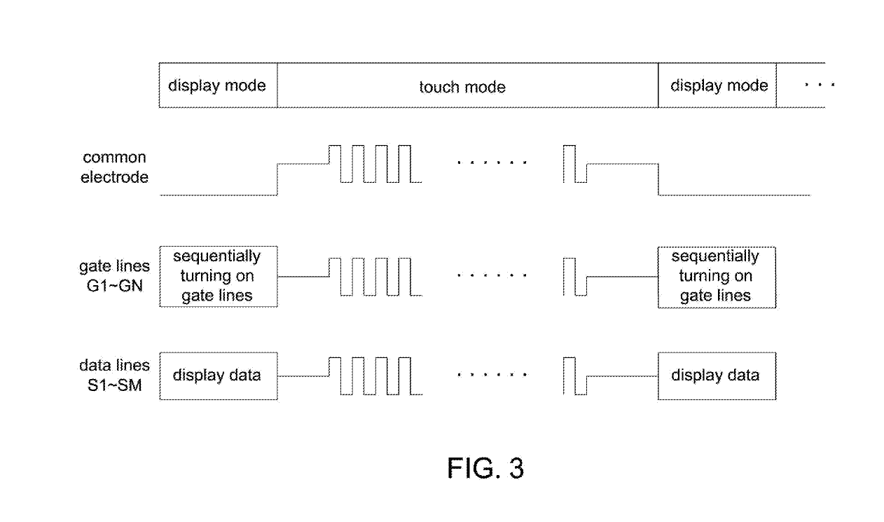

The touch display panel 100 alternately operates in a display mode and a touch mode. When operating in the display mode, the touch display panel 100 displays image data; when operating in the touch mode, the touch display panel 100 detects whether a touch point occurs thereon. More specifically, referring to FIG. 1 to FIG. 3, FIG. 3 shows a schematic diagram of signals applied to a common electrode, gate lines and data lines in a display mode and in a touch mode according to an embodiment of the present invention. When the touch display panel 100 and the driving circuit operate in the display mode, as the touch display panel 100 is used to display image data, the control and detection circuit 210 controls the blocks 202_11 to 202_BA in the common electrode to maintain a constant voltage level, i.e., a common voltage VCOM. Further, the gate drivers 130_1 to 130_Y sequentially turn on the gate lines G1 to GN, and the source drivers 120_1 to 120_X write the display data into the pixel electrodes P1 of the pixels via the data lines S1 to SM.

When the touch display panel 100 and the driving circuit operate in the touch mode, the control and detection circuit 210 inputs a driving signal to the blocks 202_11 to 202_BA, and starts detecting a voltage (capacitance) change in each of the blocks 202_11 to 202_BA. At this point, the gate drivers 130_1 to 130_Y and the source drivers 120_1 to 120_X simultaneously control the gate lines G1 to GN and the data lines S1 to SM, to cause these lines to have a signal waveform same as that of the driving signal (to cause these lines to have an amplitude change that is the same as the amplitude change in the driving signal). For example, referring to FIG. 3, assume that the signal waveform of the driving signal is a toggle pattern having a 2V amplitude. At this point, the gate drivers 130_1 to 130_Y may control the gate lines G1 to GN to have a toggle pattern between −11V to −9V to ensure that the thin-film transistors TFT in the pixel array are not turned on. Further, the source drivers 120_1 to 120_X may input the waveform that synchronously changes with the driving signal to the data lines S1 to SM. In another embodiment, the signal waveform of the driving signal may switch among three or more voltage levels, and the voltages on the corresponding gate lines and data lines also change along with the waveform of the driving signal. In yet another embodiment, the signal waveform of the driving signal may be a sinusoidal wave, and the voltages on the corresponding gate lines and data lines change along with the waveform of the driving signal. As previously described, the common electrode, the gate lines G1 to GN and the data lines S1 to SM have the same signal waveform in the touch mode. Thus, regardless of the rotation angles of liquid crystal molecules, when the touch display panel switches from the display mode to the touch mode, the capacitance value between the common electrode and the gate lines G1 to GN as well as the capacitance value between the common electrode and the data lines S1 to SM are kept at constant values. Therefore, noise interference occurring in the prior art can be prevented to further enhance the accuracy of touch detection of the control and detection circuit 210.

In the embodiment in FIG. 3, in the touch mode, the gate lines G1 to GN and the data lines S1 to SM have a signal waveform identical to that of the driving signal inputted to the common electrode. However, the present invention is not limited to the above example. In other embodiments of the present invention, only the gate drivers 130_1 to 130_Y control the gate lines G1 to GN to have a signal waveform same as that of the driving signal, whereas the data lines S1 to SM need not have any similar signal waveform. Alternatively, the source drivers 120_1 to 120_X control the data lines S1 to SM to have a signal waveform same as that of the driving signal, whereas the gate lines G1 to GN need not have any similar signal waveform. In another embodiment, only a part of the gate lines G1 to GN are controlled to have a signal waveform same as that of the driving signal, or only a part of the data lines S1 to SM are controlled to have a signal waveform same as that of the driving signal. In yet another embodiment, the gate drivers 130_1 to 130_Y may control the gate lines G1 to GN to have a signal waveform partially same as that of the driving signal instead of an entirely identical signal waveform. For example, the time of the change in the waveform is the same, with however the amount of change in the amplitude being not entirely the same; or, the amount of change in the amplitude is the same, with however the time of the change in the waveform being not entirely the same. Alternatively, the source drivers 120_1 to 120_X may control the data lines S1 to SM to have a signal waveform partially same as that of the driving signal instead of an entirely identical signal waveform.

In the above embodiments, to reduce the scanning time when operating in the touch mode, all of the gate lines and data lines in the pixel array 110 are simultaneously controlled to have a signal waveform at least partially same as that of the driving signal. However, in other embodiments of the present invention, to reduce circuit costs, the driving circuit may include only one or a few control and detection circuits 210. The control and detection circuit 210 may sequentially transmit the driving signal to the blocks 202_11 to 202_BA of the common electrode to cause the blocks 202_11 to 202_BA to sequentially perform touch detection. Further, the source drivers 120_1 to 120_X and the gate drivers 130_1 to 130_Y control multiple gate lines or multiple data lines corresponding to the blocks currently performing touch detection in the common electrode, to cause these lines to have a signal waveform at least partially same as that of the driving signal. The control and detection circuit 210 does not simultaneously control all of the gate lines and all of the data lines in the pixel array 110 to have a signal waveform at least partially same as that of the driving signal. The term “sequentially” is not limited to a fixed order and may refer to a dynamically changing order. When the blocks 202_11 to 202_BA sequentially perform touch detection, there may be multiple blocks simultaneously performing touch detection within a timing or merely one single block performing touch detection at a time. Further, given that all of the blocks complete touch detection within a period, the number of blocks that perform touch detection within a timing may be different.

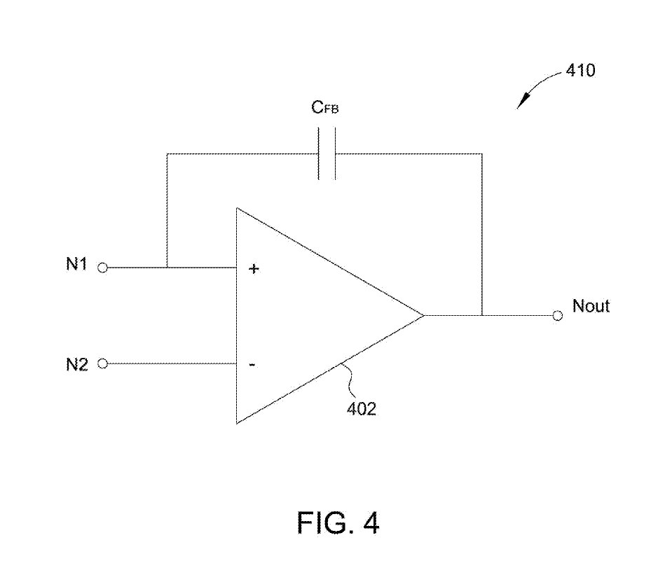

FIG. 4 shows a schematic diagram of an example of a touch driving circuit 410 in the control and detection circuit 210 in FIG. 2. As shown in FIG. 4, the touch driving circuit 410 includes an amplifier 402, a feedback capacitor C_{FB} and three nodes N1, N2 and Nout. The node N1 is connected to a corresponding block of the common electrode (one of 202_11 to 202_BA), the node N2 serves as an input node of the driving signal, and the node Nout is for detecting a capacitance change on the block of the common electrode to generate a touch detection result. More specifically, when the driving circuit operates in the touch mode, the driving signal is transmitted to the node N2. Because the two input nodes N1 and N2 have the same voltage level, the corresponding block of the common electrode connected to the node N1 also has the signal waveform of the driving signal. When a touch event is applied to that block, the capacitance generated may affect the voltage value of the node Nout. Thus, it can be determined whether a touch event occurs on that block by analyzing the voltage value of the node Nout.

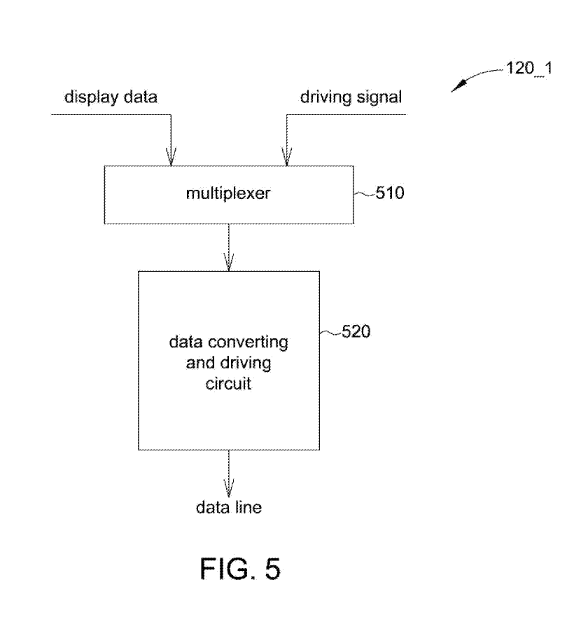

FIG. 5 shows a schematic diagram of an exemplary source driver 120_1 according to an embodiment of the present invention. As shown in FIG. 5, the source driver 120_1 includes a driving signal generating circuit and a display data generating circuit. The driving signal generating circuit includes a driving signal receiving circuit, a multiplexer 510 and a data converting and driving circuit 520. The display data generating circuit includes a display data receiving circuit, the multiplexer 510 and the data converting and driving circuit 520. The multiplexer 510 selectively transmits the display data or the driving signal to the data converting and driving circuit 520. That is, when operating in the display mode, the multiplexer 510 transmits the display data to the data converting and driving circuit 520; when operating in the touch mode, the multiplexer 510 transmits the driving signal to the data converting and driving circuit 520. In the embodiment, the display data and the driving signal are both digital data. The data converting and driving circuit 520 then transmits the received display data or driving signal to the data lines. For example, the data converting and driving circuit 520 may include a data buffer, a shift register, a digital-to-analog converter (DAC), an analog buffer amplifier . . . of a common source driver. In one embodiment, the multiplexer may receive a control signal, and selectively output display data or a driving signal according to the control signal. In another embodiment, the multiplexer may be integrated in the data converting and driving circuit 520, be placed before the DAC, and output the display data and the driving signal respectively corresponding to the display mode and the touch mode to the DAC and then to the corresponding data lines. In one embodiment, the source driver shown in FIG. 5 may be integrated in the control and detection circuit 210 in FIG. 2.

Further, the gate driver 130_1 may control a low voltage level of the gate by using a method similar to the multiplexer in the source driver to achieve the effect of outputting the driving signal in the touch mode. More specifically, a common gate driver turns off the gate by a pull-low level. One person skilled in the art may control the low voltage level by a multiplexer, i.e., controlling the gate potential in the touch mode by the driving signal. Associated details are omitted herein. In one embodiment, the gate driver may be integrated with the control and detection circuit 210 in FIG. 2.

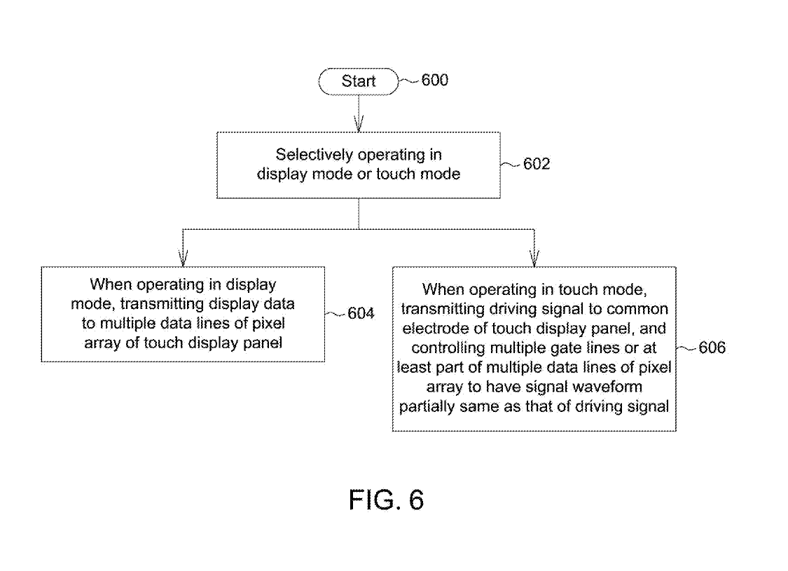

FIG. 6 shows a flowchart of a driving method of a touch display panel according to an embodiment of the present invention. Referring to FIG. 1 to FIG. 6, the process includes following steps.

In step 600, the process begins.

In step 602, the touch display panel selectively operates in a display mode or a touch mode.

In step 604, when touch display panel operates in the display mode, corresponding display data is transmitted to multiple data lines of a pixel array of the touch display panel.

In step 606, when touch display panel operates in the touch mode, a driving signal is transmitted to a common electrode of the touch display panel, and at least a part of multiple gate lines or the multiple data lines of the pixel array are controlled to cause these lines to have a signal waveform at least partially same as that of the driving signal.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A driving circuit of a touch display panel, selectively operable in a display mode or a touch mode, comprising:
a touch driving circuit transmitting a driving signal to a common electrode of the touch display panel when the driving circuit operates in the touch mode; and
a display driving circuit transmitting corresponding display data to a plurality of data lines of a pixel array of the touch display panel when the driving circuit operates in the display mode and controlling, when the driving circuit operates in the touch mode, at least a part of a plurality of gate lines and the plurality of data lines of the pixel array, to cause the controlled lines to have a signal waveform at least partially same as that of the driving signal;
wherein, a voltage of the common electrode reflects a touch action.

2. The driving circuit according to claim 1, wherein when the driving circuit operates in the touch mode, the display driving circuit controls at least a part of the plurality of gate lines and at least a part of the plurality of data lines of the pixel array, to cause the controlled lines to have the signal waveform at least partially same as that of the driving signal.

3. The driving circuit according to claim 1, wherein when the driving circuit operates in the touch mode, the display driving circuit controls all of the gate lines of the pixel array, or all of the data lines of the pixel array, to cause the controlled lines to have the signal waveform at least partially same as that of the driving signal.

4. The driving circuit according to claim 3, wherein when the driving circuit operates in the touch mode, the display driving circuit controls all of the gate lines and all of the data lines of the pixel array, to cause the controlled lines to have the signal waveform at least partially same as that of the driving signal.

5. The driving circuit according to claim 1, wherein the common electrode comprises a plurality of blocks; when the driving circuit operates in the touch mode, the touch driving circuit sequentially transmits the driving signal to the plurality of blocks to cause the blocks to sequentially perform touch detection, and the display driving circuit controls the gate lines or the data lines corresponding the blocks currently performing touch detection in the pixel array, to cause the controlled lines to have the signal waveform at least partially same as that of the driving signal; the display driving circuit does not simultaneously control all of the gate lines and all of the data lines of the pixel array to have the signal waveform at least partially same as that of the driving signal.

6. The driving circuit according to claim 1, wherein the signal waveform of the driving signal is a toggle pattern.

7. The driving circuit according to claim 1, wherein when the driving circuit operates in the touch mode, the display driving circuit controls at least a part of the plurality of gates lines of the pixel array to cause the controlled lines to have the signal waveform at least partially same as that of the driving signal, and a voltage level of the driving signal does not cause thin-film transistors in the pixel array to be turned on.

8. A driving method of a touch display panel, comprising:
selectively operating in a display mode or a touch mode; and
when operating in the display mode, transmitting corresponding display data to a plurality of data lines of a pixel array of the touch display panel; when operating in the touch mode, transmitting a driving signal to a common electrode of the touch display panel, and controlling at least a part of a plurality of gate lines and the plurality of data lines of the pixel array, to cause the controlled lines to have a signal waveform at least partially same as that of the driving signal; a voltage of the common electrode reflects a touch action.

9. The driving method according to claim 8, wherein at least a part of the plurality of gate lines and at least a part of the plurality of data lines of the pixel array are controlled to have the signal waveform at least partially same as that of the driving signal.

10. The driving method according to claim 8, wherein all of the gate lines of the pixel array or all of the data lines of the pixel array are controlled to have the signal waveform at least partially same as that of the driving signal.

11. The driving method according to claim 10, wherein all of the gate lines and all of the data lines of the pixel array are controlled to have the signal waveform at least partially same as that of the driving signal.

12. The driving method according to claim 8, wherein the common electrode comprises a plurality of blocks; the step of transmitting the driving signal to the common electrode of the touch display panel, and controlling the at least a part of the plurality of gate lines and the plurality of data lines of the pixel array to cause the controlled lines to have the signal waveform at least partially same as that of the driving signal comprises:
sequentially transmitting the driving signal to the plurality of blocks to cause the plurality of blocks to perform touch detection; and
given that all of the gate lines and all of the data lines of the pixel array are not simultaneously controlled, controlling the gate lines or the data lines corresponding to the blocks currently performing touch detection in the pixel array to have the signal waveform at least partially same as that of the driving signal.

13. The driving method according to claim 8, wherein the signal waveform of the driving signal is a toggle pattern.

14. The driving method according to claim 8, wherein when operating in the touch mode, a voltage level of the driving signal applied to at least a part of the plurality of gate lines of the pixel array does not cause thin-film transistors in the pixel array to be turned on.

15. A touch display panel, comprising:
a pixel array, comprising a plurality of gate lines and a plurality of data lines that intersect one another;
a common electrode, disposed on the pixel array; and
a driving circuit, coupled to the pixel array and the common electrode, selectively operating in a display mode or a touch mode;
wherein, when the driving circuit operates in the display mode, the driving circuit transmits corresponding display data to a plurality of data lines of the pixel array; when the driving circuit operates in the touch mode, the driving circuit transmits a driving signal to a common electrode of the touch display panel, and controls at least a part of the plurality of gate lines and the plurality of data lines of the pixel array, to cause the controlled lines to have a signal waveform at least partially same as that of the driving signal; a voltage of the common electrode reflects a touch action.

16. The touch display panel according to claim 15, wherein when the driving circuit operates in the touch mode, the display driving circuit controls at least a part of the plurality of gate lines of the pixel array, or at least a part of the plurality of data lines of the pixel array, to cause the controlled lines to have the signal waveform at least partially same as that of the driving signal.

17. The touch display panel according to claim 15, wherein when the driving circuit operates in the touch mode, the driving circuit controls all of the gate lines of the pixel array, or all of the data lines of the pixel array, to cause the controlled lines to have the signal waveform at least partially same as that of the driving signal.

18. The touch display panel according to claim 17, wherein when the driving circuit operates in the touch mode, the driving circuit controls all of the gate lines and all of the data lines of the pixel array, to cause the controlled lines to have the signal waveform at least partially same as that of the driving signal.

19. The touch display panel according to claim 15, wherein the common electrode comprises a plurality of blocks; when the driving circuit operates in the touch mode, the driving circuit sequentially transmits the driving signal to the plurality of blocks to cause the blocks to sequentially perform touch detection, and controls the gate lines or the data lines corresponding the blocks currently performing touch detection in the pixel array, to cause the controlled lines to have the signal waveform at least partially same as the that of the driving signal; the driving circuit does not simultaneously control all of the gate lines and all of the data lines of the pixel array to have the signal waveform at least partially same as that of the driving signal.

20. The touch display panel according to claim 15, wherein the signal waveform of the driving signal is a toggle pattern.
